(19) United States
(12) Patent Application Publication
(10) Pub. No.: US 2012/0282410 A1
(43) Pub. Date: Nov. 8, 2012

(54) APPARATUS AND METHOD FOR RECOVERY AND DRY TREATMENT OF OVERSPRAY IN A PAINTING BOOTH

(75) Inventor: Giampaolo Covizzi, Milan (IT)

(73) Assignee: GEICO S.P.A., Cinisello Balsamo (IT)

(21) Appl. No.: 13/513,420

(22) PCT Filed: Nov. 4, 2010
(86) PCT No.: PCT/IB10/54992

§ 371 Date: Jul. 18, 2012

(30) Foreign Application Priority Data
Dec. 2, 2009 (IT) MI2009A002136

(51) Int. Cl. B05B 15/12; B05D 1/02

(52) U.S. Cl. 427/421.1; 118/326

(57) ABSTRACT

A liquid-paint painting booth (10) comprises a painting chamber (11) inside which the liquid paint is sprayed and which is provided with a grille-lined floor (15) for sucking from the chamber an air flow which is then conveyed to a filter unit (20, 26) for filtering the air and separating the overspray with the aid of neutralizing powders which are introduced into the air flow up-stream of the filter unit. The air flow is sucked from the chamber through at least one conduit (17), the inlet of which is close to and underneath the grille-lined floor, whereby outlet mouths (23) for a laminar flow of powder transverse to the inlet and substantially parallel to the grille-lined floor of the chamber are provided in the vicinity of the sides of the conduit inlet, so that the laminar flow is passed through by the said air flow leaving the chamber via the conduit.

The present invention relates to a spray-painting booth with an innovative overspray suppression system. The invention also relates to a suppression method. In the art relating to spray painting using liquid paints the problem of so-called “overspray”, namely the excess atomized paint which remains suspended within the atmosphere of the booth, is well-known.

For this reason, liquid-paint painting booths, provided with an air flow which passes through the working zone in order convey the paint overspray outside of the booth via suitable grilles in the floor, are widely used. The air which is drawn off must, however, be purified of the paint before it can be released into the environment or reintroduced into the booth. For this purpose, various separation systems, for example of the electrostatic type or using integrated filters suitable for filtering the liquid particles, have been proposed. These systems are generally complex and require a large amount of maintenance owing to the adhesive nature of the paint.

Powder neutralization systems have also been proposed, where the air flow is conveyed through a filtering system composed of a chamber into which a suitable powder-type neutralizing product is blown and normal powder filters. The liquid particles of paint which enter the chamber are thus absorbed and encapsulated by the particles of powder which saturate the chamber atmosphere in the form of a suspension and are then retained by the filters.

This system requires, however, a relatively large quantity of powder in order to saturate adequate the chamber atmosphere. This results in the need for frequent maintenance of the filters in order to prevent complete blockage thereof. Moreover, the large quantities of used powder which are generated give rise to high disposal costs.

However, the substantially random distribution of the powder inside the chamber may not be sufficient to prevent adhesion of the paints onto the walls of the chamber.

If the liquid paint suspended in the air flow which must pass from the booth to the chamber containing the powder is not neutralized sufficiently in advance, the powder may also create further maintenance problems owing to the amount of overspray paint which is deposited on the air evacuation and transportation ducts. It has also been proposed blowing air cushions, to which powder has been added, along walls conveying the air flow containing the paint which is still in the liquid phase. This reduces adhesion of the paint to the duct walls, but increases still further the amount of powder used and reduces the efficiency of the system. Moreover, these additional flows may disturb the main air flow which evacuates the air from the painting chamber and this may result in a defective evacuation of the overspray and/or the return of powder towards the painting chamber.

The main object of the present invention is to provide a suppression method and a painting booth with an overspray suppression system using powder neutralization, able to ensure a low powder consumption, high efficiency and reduced maintenance of the plant.

In view of this object the idea developed according to the invention is to provide a liquid-paint painting booth, comprising a painting chamber inside which the liquid paint is sprayed and which is provided with a grille-lined floor for sucking from the chamber an air flow which is then conveyed to a filter unit for filtering the air and separating the paint overspray with the aid of neutralizing powders which are introduced into the air flow upstream of the filter unit, characterized in that the air flow is sucked from the chamber through at least one conduit, the inlet of which is close to and underneath the grille-lined floor, whereby outlet mouths for a laminar flow of powder transverse to the inlet and substantially parallel to the grille-lined floor of the chamber are provided in the vicinity of the sides of the conduit inlet, so that said laminar flow is passed through by the said air flow leaving the chamber via the conduit.

Another idea developed according to the invention is to provide, in a liquid-paint painting booth, a method for suppression of the overspray in the air flow which is sucked through the grille-lined floor of the booth, comprising the step of blowing neutralizing powder parallel to and below the grille-lined floor of the booth so as to form a powder neutralizing barrier which is passed by the air flow which leaves the booth through the floor and is then filtered using powder filters.

In order to illustrate more clearly the innovative principles of the present invention and its advantages compared to the prior art, an example of embodiment applying these principles will be described below, with the aid of the accompanying drawings. In the drawings:

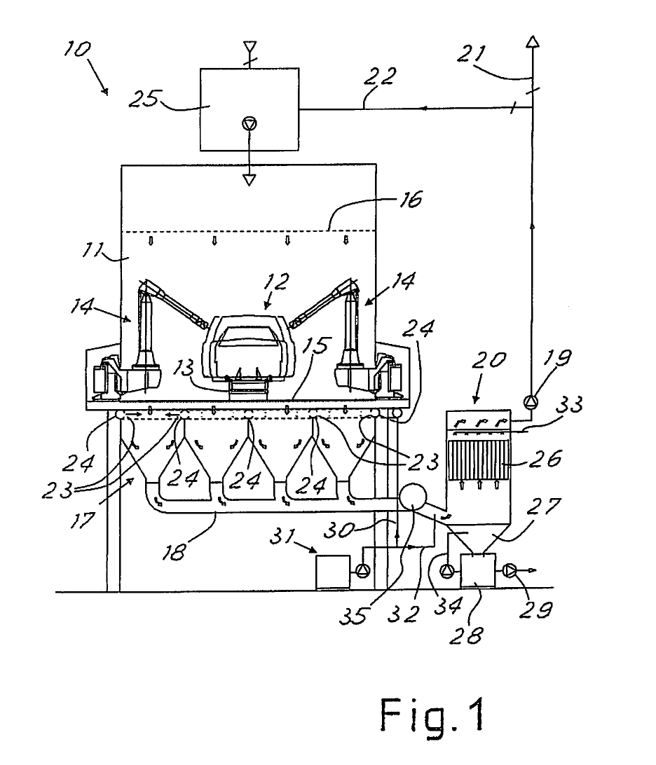

FIG. 1 shows a schematic cross-sectional view of a painting booth provided according to the invention;

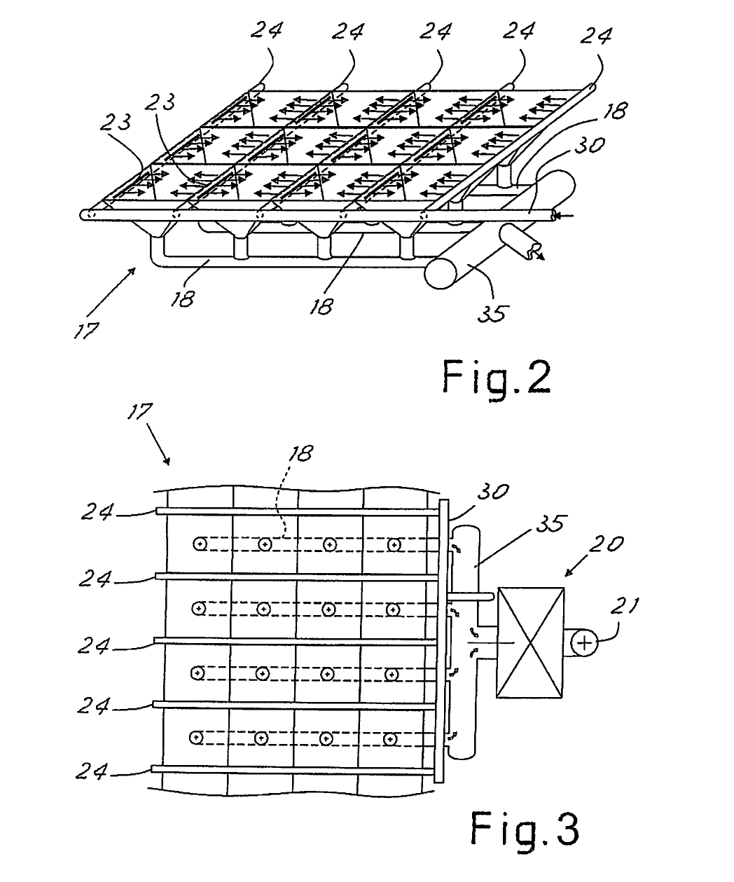

FIG. 2 shows a perspective, schematic and partial view of the system present underneath the floor of the chamber according to FIG. 1;

FIG. 3 shows a schematic plan view of a possible variant with regard to connection of the system present underneath the floor of the chamber.

With reference to the figures, FIG. 1 shows a painting booth, denoted generally by 10, provided according to the invention.

The booth comprises a chamber 11 for painting objects 12 (for example vehicle chassis). The objects to be painted are advantageously transported inside the chamber 11 by means of a known conveyor system 13.

The chamber 11 contains painting devices 14 which, when operated, spray liquid paint over the surfaces of the object to be painted. Advantageously, the painting devices may be formed by robot arms of the known type terminating in spray guns or cups.

The floor 15 of the chamber 11 is composed of grilles through which the air of the chamber is sucked so as to evacuate the overspray from the chamber. The ceiling of the chamber is provided with air inlets 16 which are also advantageously formed by grilles and filters so as to have a continuous air flow which passes vertically through the chamber from the top to the bottom during the painting operations.

The grille-lined floor 15 is provided, underneath, with funnel conduits 17 (advantageously having the form of an inverted pyramid) which connect the area underneath the grilles to evacuation ducts 18 which convey the air flow (moved by an aspirator 19) via a connection duct 35 to a filtering unit 20 suitable for filtering powders.

The air leaves the filtering unit 20 in a purified state so as to then be evacuated outside through a duct 21 and/or conveyed back to the ceiling of the chamber via a duct 22. An air supply system 25, which may be equipped with associated known air-conditioning systems, is provided so as to be able to perform recirculation or complete renewal of the air.

As can be clearly seen in FIG. 2 also, each conduit 17 has a rectangular top inlet, the opposite sides of which are provided with mouths 23 for blowing neutralization powder into the horizontal plane of the inlet. The mouths are arranged so as to create a horizontal layer of blown powder directly underneath the floor grille. The blowing direction and the air flow entering through the floor prevent the painting chamber from becoming polluted with powder.

Advantageously, the conduits are arranged underneath the floor in an orderly chequered arrangement of rows and columns forming a conduit surface which occupies the entire grille-lined floor. A complete row of conduits forms a conduit module which is served by a pair of ducts 24 provided along their length with said powder delivery mouths 23. Advantageously, the mouths consist of one or more long slits formed in the wall of each duct so as to occupy the entire side of the respective conduit. The ducts may have mouths on opposite sides so as to serve two conduits arranged in adjacent columns in the conduit surface. The system may thus advantageously have a modular design so that it can be adapted to booths of varying area by simply arranging alongside each other several conduits in a module and several modules together. The ducts are connected together by a duct 30 supplying powders from a feeder unit with pumping system 31.

The size of the top inlet of each conduit may thus be chosen sufficiently small to allow the formation of an effective transverse barrier of powder.

According to the principles of the invention the powder may be supplied by means of a transportation air flow in a sufficient amount to form a thin barrier of powder substantially horizontal and transverse to the main air flow sucked through the floor of the booth in order to evacuate the overspray. Owing to this solution, all the air flow which transports the overspray through the barrier of powder and the suspended droplets of liquid paint are intercepted by the neutralizing powder barrier substantially before they come into contact with anything inside the evacuation system. With the system according to the invention a limited amount of powder is required, it not being required to saturate the atmosphere of a large neutralization chamber and/or produce powder-containing air cushions along walls which are exposed to the air flow conveying the overspray.

Moreover, the air flow which passes through the conduits and reaches the filtering unit contains practically only powder which has absorbed the liquid overspray paint.

The filtering unit 20 may thus advantageously be composed of simple filters 26 for solid particles, for example of the bag, cartridge, plate or rigid-membrane type. If desired, it is also possible, by means of a duct 32, to introduce a small flow of powder immediately to the inlet of the filtering unit.

As can be seen again in FIG. 1, the filtering unit has filters which are advantageously arranged above a hopper 27 and which are passed through by the air flow in a vertical upwards direction.

The powder which is accumulated upstream of the filters may thus be easily made to fall into the hopper and is evacuated by means of an underlying storage container 28 provided for example with transportation means 29 for conveying the powders to a storage silo (not shown).

In order to help keep the filters clean, cleaning cycles may advantageously be performed using a backflow of pressurized air, introduced downstream of the filters by means of a pressurized duct 33. During the cleaning cycles, an additional powder flow 34 may also be introduced upstream of the filters in order to ensure greater protection of the filters against the overspray.

FIG. 3 shows a possible variant of the arrangement of the connections of the conduits to the ducts of the filters and the powder supply mouths. In this variant the ducts 18 are arranged parallel to the ducts 24. This allows the connection ducts 30 and 35 to be arranged on the same side of the plant and thus results in a greater modular capacity in the event of an increase in the floor size and the need for a greater number of conduits in the chequered arrangement.

At this point it is clear how the predefined objects have been achieved. As a result of the method according to the invention and the booth according to the invention, a minimum amount of neutralizing powder is required. Moreover, the risk of soiling the evacuation plant with liquid paint dispersed in the air flow is reduced to a minimum. A very small amount of maintenance is required for the entire plant and the cleaning cycles may be performed automatically at intervals which may also be relatively long, without periodic stoppage of the air flow. The fact that the filter unit is separate from the rest of the booth and connected by means of ducts means that the filters can be accessed and maintained more easily. Obviously, the above description of an embodiment applying the innovative principles of the present invention is provided by way of example of these innovative principles and must therefore not be regarded as limiting the scope of the rights claimed herein. For example, the powder delivery mouths may be designed in various alternative forms, for example comprising single adjacent nozzles, a number of supply ducts, a tangential supply system, etc. The powder may be advantageously based on micronized calcium carbonate, but also other types of powder for neutralizing the liquid paint may be used. The dimensions and proportions of the plant may obviously vary depending on the specific requirements. The number of conduits may vary from one to a higher number, depending also on the dimensions of the floor. The modular structure of the conduits allows easy adaptation of the plant to different-size booths, something which is to difficult or impossible to achieve with the known plants performing powder neutralization of the liquid overspray.

The filtering units may also be more than one in number, each acting on the air flow leaving a subassembly of conduits.

1. A liquid-paint painting booth, comprising:
a painting chamber provided with a grille-lined floor;
at least one conduit provided with an inlet that is underneath the grille-lined floor;
a filter unit; and
at least one outlet mouth in a vicinity of the inlet of the at least one conduit;
wherein the booth is configured to spray liquid paint inside the painting chamber,
wherein the booth is configured to allow air flow, including paint overspray, to be sucked from the painting chamber through the grille-lined floor and the at least one conduit, and conveyed to the filter unit,
wherein the at least one outlet mouth is configured to introduce a laminar flow of neutralizing powder into the air flow upstream of the filter unit
wherein the laminar flow of neutralizing powder is transverse to the inlet of the at least one conduit and substantially parallel to the grille-lined floor,
wherein the air flow, including paint overspray, sucked from the painting chamber through the grille-lined floor and the at least one conduit passes through the laminar flow of neutralizing powder, and
wherein the filter unit is configured to filter the air flow and to separate the paint overspray using the neutralizing powder.

2. The booth of claim 1, wherein the at least one outlet mouth includes slits formed in powder supply ducts, and
wherein the slits are arranged parallel to each other on opposite sides of the inlet of the at least one conduit.

3. The booth of claim 1, further comprising:
a plurality of conduits arranged alongside each other in rows and columns in a plane parallel to the grille-lined floor;
wherein each of the conduits has at least one outlet mouth providing a respective laminar flow of neutralizing powder transverse to the inlet of the respective one of the conduits.

4. The booth of claim 2, further comprising:
a plurality of conduits provided with inlets that are underneath the grille-lined floor; and
a common duct for supplying the neutralizing powders;
wherein the common duct has, on opposite sides, a plurality of mouths for emitting the neutralizing powder into the conduits, and
wherein the mouths are present between adjacent conduits.

5. The booth of claim 1, wherein the filter unit is separate from the at least one conduit, and
wherein the filter unit is connected to the at least one conduit by ducts.

6. The booth of claim 1, wherein the air flow passes through the filter unit in a vertical, upward direction.

7. The booth of claim 1, further comprising:
a hopper arranged underneath the filter unit in order to collect neutralizing powder captured by the filter unit.

8. The booth of claim 1, further comprising:
a compressed-air inlet downstream of the filter unit so as to convey a backflow of compressed air through the filter unit during a cleaning cycle.

9. The booth of claim 1, wherein filters of the filter unit are of a bag, cartridge, plate, or rigid-membrane type.

10. The booth of claim 1, wherein the neutralizing powder is micronized calcium carbonate.

11. A method for suppressing paint overspray in a painting chamber of a liquid-paint painting booth, the method comprising:
sucking air flow, including the paint overspray, from the painting chamber through a grille-lined floor of the booth;
blowing neutralizing powder below and substantially parallel to the grille-lined floor so as to form a powder neutralizing barrier;
causing the air flow, including paint overspray, sucked from the painting chamber through the grille-lined floor to pass through the powder neutralizing barrier; and
filtering the air flow, including paint overspray, using powder filters.

12. The method of claim 11, wherein the neutralizing powder is micronized calcium carbonate.

13. The booth of claim 3, further comprising:
a common duct for supplying the neutralizing powder;
wherein the common duct has, on opposite sides, a plurality of mouths for emitting the neutralizing powder into the conduits, and
wherein the mouths are present between adjacent conduits.
